(19) United States
(12) Patent Application Publication
(10) Pub. No.: US 2009/0327734 A1
(43) Pub. Date: Dec. 31, 2009

(54) MATCHING A WATERMARK TO A HOST SAMPLING RATE

(75) Inventors: Javier Francisco Aprea, Eindhoven (NL); Aweke Negash Lemma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,140

(22) PCT Filed: Dec. 7, 2007
(86) PCT No.: PCT/IB2007/054960

§ 371 Date: Jun. 8, 2009

(30) Foreign Application Priority Data
Dec. 12, 2006 (EP) 06125886.9

(51) Int. Cl. H04L 9/32

(52) U.S. Cl. 713/176

(57) ABSTRACT

The invention deals with matching of a watermark to a host sampling rate of a multimedia signal. A watermark sampled at a first sampling rate is matched to multimedia host signal sampled at a second sampling rate, in a process where the watermark sampled at the first sampling rate is received, a scaling factor between the first sampling rate and the second sampling rate is determined, and re-scale widths of the watermark symbols are set. A modified watermark is generated wherein the watermark symbols of the modified watermark being of re-scale widths, so as to substantially match the modified watermark sequences to the second sampling rate.

### FIELD OF THE INVENTION

The invention relates to watermarking of multimedia signals, and in particular to watermarking with sampled watermarks.

### BACKGROUND OF THE INVENTION

Digital watermarking is a technology that may be used for a variety of purposes, such as proof of copyright ownership, tracing of illegal copies, controlling copy control equipment, broadcast monitoring, authenticity verification, adding auxiliary information into multimedia signals, etc.

In consumer digital devices, like the CD, the nominal sampling frequency is 44.1 kHz. In designing audio watermarking algorithms this is the sample rate of choice. However, for high-end audio equipment one finds 48 kHz and higher sampling rates, and also lower sampling rates may be chosen for given purposes. At these rates (i.e. rates other than 44.1 kHz) optimization of the watermark done for a sample rate of 44.1 kHz may result in the watermark not being detected properly or the watermark channel not being optimally used.

A solution is to re-sample the input and output signals by a non-integer factor and use a high-quality band-bass filter. However, this extra computational overhead is quite expensive.

Another solution is to match the watermark sampled and optimized at a given frequency to another frequency includes zero-padding of the watermark, however such a method wastes watermark channel by carrying less information than possible.

The published US patent application 2003/0004589 discloses methods of embedding and detecting a watermark in an information signal which are robust for sample rate conversions. A method is disclosed where the watermark is embedded in the information signal sampled at a first sampling rate and where the watermark is to be detected at a second sampling rate. In order to provide a watermarking scheme which is robust against sample rate conversion, a watermark is generated which have special properties in the frequency domain. The disclosure is an example of the practice that watermarks typically are optimized for the sampling rate of the information signal into which it is to be embedded. Optimization of the watermark to a first sampling rate is a computational heavy task, application of the optimized watermark at a second sampling rate, typically requires re-optimization. There is therefore a need in the art for providing a solution other than straight-forward re-sampling or zero-padding for adapting a watermark already generated for a given sampling frequency for embedding and detection at a different sampling frequency.

### SUMMARY OF THE INVENTION

The inventors of the present invention have had the insight that a watermark sampled at a first frequency can be matched to a signal of a second frequency, by approximate re-sampling using a number of integer re-scale factors. In general, the present invention seeks to provide an improved way of handling watermarks generated for a given sampling frequency to be embedded and/or detected at a different sampling frequency. Preferably, the invention alleviates, mitigates or eliminates one or more of the above or other disadvantages singly or in any combination.

According to a first aspect of the present invention there is provided, a method of matching a watermark sampled at a first sampling rate to multimedia host signal sampled at a second sampling rate, the method comprising:

receive the watermark sampled at the first sampling rate, the watermark being based on a number of watermark sequences, each watermark symbol of each watermark sequence being repeated by a first integer width;

determinate the scaling factor between the first sampling rate and the second sampling rate, and determine a first re-scale width of the watermark symbols so as to approximate the watermark sequences to the second sampling rate, and set at least two integer re-scale widths, wherein at least a second re-scale width being larger than or equal to the first re-scale width and at least a third re-scale width being smaller than or equal to the first re-scale width;

generate a modified watermark based on the number of watermark sequences, wherein the watermark symbols of the modified watermark being of either the at least second or third re-scale width, so as to substantially match the modified watermark sequences to the second sampling rate.

The invention is particularly but not exclusively advantageous for providing a solution of matching a watermark to a different sampling frequency than the sampling frequency to which it was generated. That is to transform a watermark obtained at a reference frequency to a target frequency. In the present invention, a method is proposed that combines the simplicity of matching the watermark pattern to the sampling frequency at embedding and transmitting the maximum watermark energy allowed at a given audio quality.

In an advantageous embodiment, a modified watermark window may be calculated so that a circular buffer of modified watermark sequences is generated. The circular buffer may be generated so that the number of sub-windows of the modified watermark window is the minimum number of sub-windows, under the constraint that a boundary error is minimized. By generating a circular buffer, accumulation of errors of the modified watermark sequences is avoided, so that the modified watermark sequences may be repeated indefinitely. By applying a minimal buffer the embedding process is rendered less complex, since the smallest buffer is applied.

In advantageous embodiments, the modified sequence of watermark symbols is convoluted with a window shaping function. The convolution is performed so as to form a smoothly varying signal, in addition the width and/or order of the symbols of the modified sequence and the offset of the watermark window's sub-windows or window shaping function may advantageously be chosen under the constraint that a boundary error is minimized. The boundary error may be the error obtained at a sub-window boundary, such as at a local maximum, when comparing the modified watermark, or modified watermark window, with the watermark, or watermark window, obtained with direct re-sampling.

In a second aspect of the invention, an apparatus for matching a watermark sampled at a first sampling rate to multimedia host signal sampled at a second sampling rate, the apparatus comprising:

a receiver unit for receiving the watermark sampled at the first sampling rate, the watermark being based on a number of watermark sequences, each watermark symbol of each watermark sequence being repeated by a first integer width;

a determination unit for determining the scaling factor between the first sampling rate and the second sampling rate, and determine a first re-scale width of the watermark symbols so as to approximate the watermark sequences to the second sampling rate, and set at least two integer re-scale widths, wherein at least a second re-scale width being larger than or equal to the first re-scale width and at least a third re-scale width being smaller than or equal to the first re-scale width;

a modifier unit for generating a modified watermark based on the number of watermark sequences, wherein the watermark symbols of the modified watermark being of either the at least second or third re-scale width, so as to substantially match the modified watermark sequences to the second sampling rate.

In a third aspect a watermark host signal is provided, where the watermark comprise a number of watermark sequences, wherein the watermark symbols being of either an at least second or third re-scale width, so as to substantially match the watermark sequences to the sampling rate of the host signal.

In a fourth aspect of the invention is provided a computer readable code for implementing the first aspect of the invention.

The invention in accordance with the various aspects may in general be used for sample-rate dependent signal processing to synchronize between transmitted signal and carrier by scaling transmitted signal to a given target rate of the carrier.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1A schematically illustrates a watermark sequence;

FIG. 1B illustrates a watermark window with 56 samples sampled at 44.1 kHz;

FIG. 2A schematically illustrates the watermark window of FIG. 1B when applied to 48 kHz;

FIG. 2B schematically illustrates a modified watermark window in accordance with embodiments of the present invention;

FIG. 3 illustrates is a flow diagram of method steps of re-sampling of the watermark;

FIG. 4 illustrates flowchart of an embodiment in accordance with the present invention for embedding a watermark into a multimedia signal.

FIG. 5 schematically illustrates an apparatus for matching a watermark sampled at a first sampling rate to multimedia sampled at a second rate;

FIG. 6A illustrates the watermarks window of FIG. 1B re-sampled to 32 kHz;

FIG. 6B illustrates a modified watermark window in accordance with embodiments of the present invention.

### DESCRIPTION OF EMBODIMENTS

The generation, embedding and detection of a watermark into a multimedia signal, may be done at a number of ways. The published patent applications WO 03/083858, WO 03/083860 and WO 05/029466 disclose such methods, and they are hereby incorporated by reference. In the present invention, a watermark sampled at a first sampling rate is matched to a multimedia host signal sampled at a second sampling rate. Having matched the watermark to the sample frequency of the multimedia signal, the matched watermark may be embedded into the multimedia signal by a known embedding technique, e.g. as disclosed by the three mentioned published patent applications. The watermark may be embedded in continuation of the matching process at the same location and possible by the same equipment, however, the matched watermark may also be transmitted via a communication line, such as the Internet or other computer network or via a record carrier, for later implementation at another site.

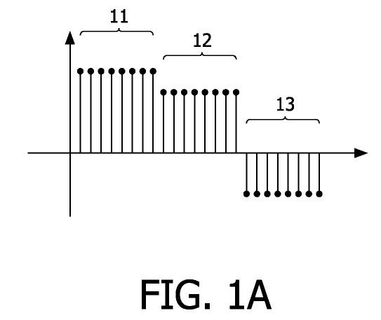

FIG. 1A schematically illustrates a watermark sequence where each watermark symbol 11, 12, 13 has been repeated by an integer width (a first integer width), here 8, however other integer widths may be applied, such as 2, 4, 6, 10 or even more or less. Typically, the watermark sequence is generated as a sequence of single symbols which is inputted into a sample repeater for generating the sequence with repeated symbols. Such a signal may also be referred to as a pulse train with a pulse width or a rectangular wave signal. The sequence may be a sequence of random or pseudo-random numbers in the range of [−1, +1]. The sequence may be generated by a random number generator with an initial seed. In FIG. 1A only three symbols are shown, a typical sequence is of 1024 numbers, alternative sequence lengths include 512 and 2048 numbers. To avoid high-frequency shifts of the pulse train, each symbol in the sequence of watermark symbols is convoluted with a window shaping function so as to form a smoothly varying signal, the width of the window shaping function being adapted to the width of the symbols of the watermark sequence An example of a window shaping function is illustrated by reference numeral 10. The illustrated window shaping functions 10 are illustrated as triangular functions, however typically another shape is applied, such as a raised cosine function or other ‘smooth’ functions. In general, the watermark is based on a number of watermark sequences, possibly a reference sequence and one or more shifted sequences, the shift(s) representing the payload. It is to be understood, that the invention is not limited to the type of watermark illustrated in FIG. 1A, this watermark is only provided as an example.

A watermark window may be provided based on a given ordering and construction of the reference sequence and the one or more shifted sequences.

FIG. 1B illustrates an example of a watermark window with 56 samples (as denoted by reference numeral 18), sampled at a first sampling rate, such as 44.1 kHz. This window is applied to each watermark symbol and the resulting watermark signal is stored in a circular watermark payload buffer to be embedded through an audio file. Sub-divisions of 4 samples, as denoted by reference numeral 15, are shown to illustrate the discrete nature of the watermark window. Other types of watermark windows may be applied, as known to the skilled person.

A watermark window in the context of this application corresponds to a sequence of partially superposed sub-windows (in FIG. 1B the sub-windows being indicated as 0, 1, 2, . . . ) to be applied to each symbol of the respective sequence.

Also in FIG. 1B are the window shaping functions 14 illustrated as triangular functions, however as mentioned above, typically a raised cosine function or other ‘smooth’ function is applied. The watermark window as illustrated here include 7 sequences denoted 0 to 6, the sequence denoted 0 being a first sequence, called reference sequence, whereas the 6 sequences denoted 1 to 6 are cyclically shifted versions of the reference sequence or any other chosen sequence. In an embodiment, the even sequences 2, 4, 6 are circularly shifted versions of a second sequence, and the uneven sequences 1, 3, 5 are circularly shifted versions of a third sequence. The inclusion of a reference sequence and one or more circularly shifted sequences enables carrying a payload in the signal. Moreover, the sequences are repeated once, so that for the second seven sequences 17, the sign of the first seven sequences 16 are inverted. Thus, if a symbol is positive in the first sequence 16, it is negative in the second sequence 17, and vice versa. The application of such a sequence of window function provides a very robust watermark, while being imperceptible to the human observer.

In an embodiment, let the sequence of FIG. 1A represent the reference sequence, the first watermark symbol 11 is point-wise multiplied with the samples of the watermark window at sequence 0 of FIG. 1B. The second watermark symbol 12 is point-wise multiplied with the samples of the watermark window at sequence 0 of a next (second) watermark window (not shown), and the third watermark symbol 13 is point-wise multiplied with the samples of the third watermark window at sequence 0 (not shown), etc. The sequences 1 to 6 would carry circularly shifted sequences of the reference sequence or any other sequence.

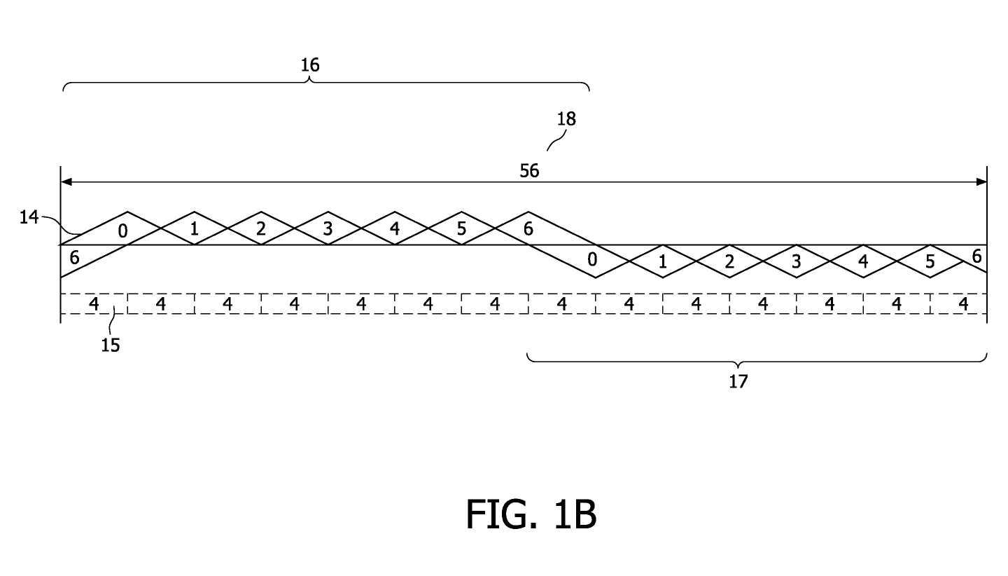

FIG. 2A schematically illustrates the watermark window of FIG. 1B when direct re-sampled to 48 kHz, i.e. re-sampled by a non non-integer factor. In this situation, the 56 samples of the watermarks window at 44.1 kHz (FIG. 1B) is re-sampled to 60.95 samples. In order to apply this watermark window, the use of a high-quality low-pass filter is needed, but this is computational quite expensive. In the solution in accordance with the present invention, the watermark pattern is matched to an integer sampling rate, by a simple and direct way.

A re-sampled watermark window (or a modified watermark window) in accordance with embodiments of the present invention is schematically illustrated in FIG. 2B. It is to be understood, that while the watermark sampled at the first frequency, may have been convoluted with a window shaping function before the matching process begins, in general, the convolution with the window shaping functions is applied in connection with the matching process.

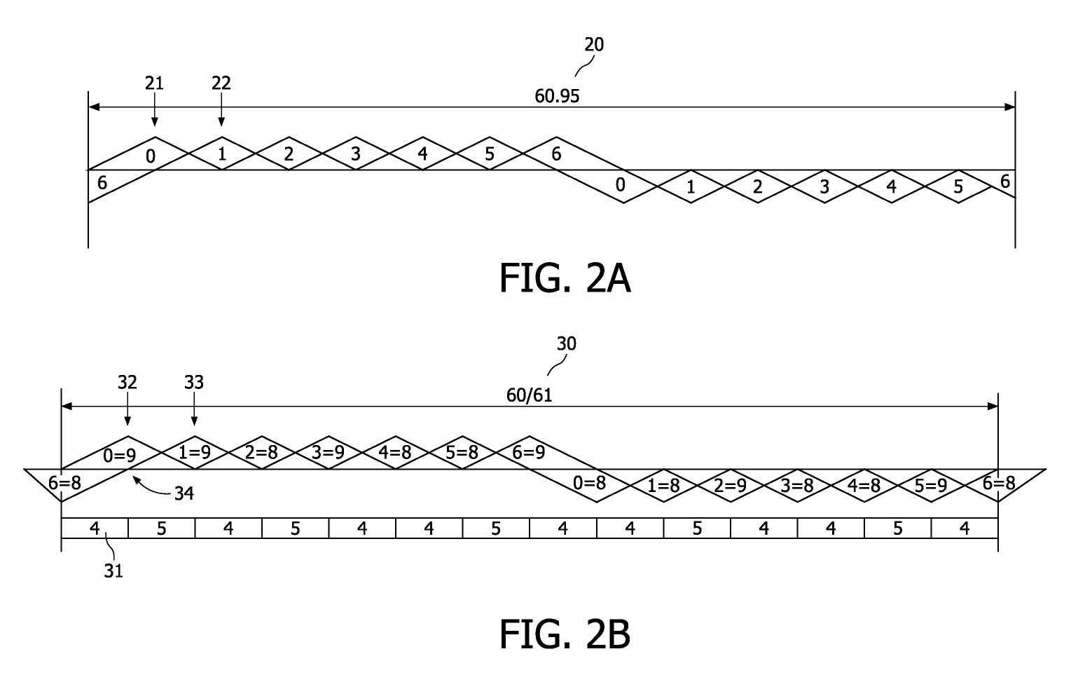

The re-sampling of the watermark window is explained in connection with FIG. 2B in combination with the method steps of FIG. 3.

In a first step 41 the watermark sampled at the first sampling rate is received or accessed.

In a next step 42, a scaling factor between the first sampling rate and the second sampling rate is determined, here being 1.088, resulting in a single scaling factor or width, referred to as the first re-scale width, of the watermark symbols, here being 8.707, so as to match the watermark sequences to the second sampling rate. Applying this scaling width would result in the watermark window as shown in FIG. 2A. Two integer re-scale widths are set, referred to as the second and third re-scale widths. The second re-scale width being larger than or equal to the first re-scale width and at least a third re-scale width being smaller than or equal to the first re-scale width. The second and third re-scale width are typically set to be different, and at least in situations where the first and the second sampling rates are not integer multiplicative of each other, the second and third re-scale width are set to be different. In the situation where the first and the second sampling rates are integer multiplicative of each other, the first, second and third re-scale width are equal. In such a situation, the present invention may still advantageously be applied in order to avoid any need for use of high-quality band pass filtering. However, in general also more than two re-scale widths may be set and applied, in this case some of the re-scale widths are set to be larger and some are set to be smaller than the first re-scale width. In an embodiment, the second re-scale width is set as the integral part, or modulo, of the first re-scale width, and the third re-scale width is set as the second re-scale width incremented by 1. In this case, the first re-scale width is therefore set to 8, and the second re-scale width is set to 9.

In a next step 43, a modified watermark is generated, so that the corresponding watermark symbols of the modified watermark being of either the second or third re-scale widths, so as to substantially match the watermark sequences to the second sampling rate.

FIG. 2B illustrates a schematic example of a modified watermark window for 48 kHz. The number of samples is set to either 60 or 61 (as denoted by reference numeral 30). Having a large number of modified watermark windows will result in that the average number of samples approaches a value of 60.95 or a value close to this value. Instead of all watermark symbols being repeated with a single width of 8, as schematically illustrated in FIG. 1A, widths of either 8 (the second re-scale width) or 9 (the third re-scale width) is applied, as indicated by the sub-divisional of 4 and 5 samples as denoted by reference numeral 31. The sub-divisional of 4 and 5 is shown for illustrating the width of the sub-windows with respect to the sample spacing. Whether 60 or 61 samples are used for a given modified watermark window depends on the specific routine to determine the ordering of the sub-windows of different widths. Below an embodiment for generating a sequence of modified watermark symbols which represents the minimum number of elements in order to provide a circular buffer is discussed. In this embodiment constraints are set up to chose the ordering of sub-windows of widths 8 and 9, whether 60 or 61 samples are used, automatically drops out of the routine.

In an embodiment, the modified watermark is calculated so that a circular buffer of modified watermark sequences is generated. The total number of sequences in the modified watermark sequences may be provided, such that the total number is the minimum number of sequences needed to provide a circular buffer under the constraint that the errors obtained at boundaries, e.g. sub-window local maxima, are minimized.

Moreover, the modified sequence of watermark symbols may be convoluted with a window shaping function so as to form a smoothly varying signal. The width of the window shaping function is adapted to the width of the symbols of the modified watermark sequence.

And even further, the window shaping function for at least some of the symbols of the modified watermark sequence may be offset by an integer value. The offset may in an embodiment be in the range of the integral of half the smaller re-scale width, incremented by 1 or decreased by 1.

The sequence of modified watermark symbols which represents the minimum number of elements in order to provide a circular buffer, may be provided under the constraint that boundary errors are minimized at local window maxima, by properly choosing the order of the second and third re-scale widths and by properly choosing the presence and order of offsets of window shaping functions.

In an embodiment, the watermark sequence of a circular buffer is generated by using a repeating method. The result for the watermark window of FIG. 1B is shown in FIG. 2B.

In a first step, the width is set to 9, since the error made at the window maximum 32 is smaller for a width of 9 than for a width of 8, as compared to the corresponding window maximum of the re-sampled version 21. To minimize the error made at the next window maximum 33 as compared to the re-sampled version 22, one may chose an offset of 4 or 5 and a width of 8 or 9. The minimum error is for an offset of 4 (as indicated by reference numeral 34) and a width of 9, for the next window, an offset of 9 and a width of 8 is found. In principle, boundary errors may be minimized at any given boundary along a window, window maxima are chosen since, after the application of a window shaping function, the watermark energy is maximum at the window maxima, thus the probability of detecting the watermark is maximal there, and the best conditions for ensuring proper detection is typically provided by minimizing errors at window maxima.

The window offsets, widths and errors may be calculated by the following C-code resulting in the values as shown in TABLE 1.

The C-code for generating the numbers of TABLE 1 is the following:

```
int fGCD( int a, int b )
{
      int c;
      if ( b > a ) {
          c = b; b = a; a = c;
      }
      c = 1;
      while ( c != 0 ) {
          c = a % b; a = b; b = c;
      }
      return a;
}
int main( int argc, char* argv[ ] )
{
```

| | |
|---|---|
| int f = 44100; | /* reference frequency */ |
| int g = 48000; | /* audio frequency */ |
| int d = 4; | /* nominal window shift = ½ window length */ |
| int s = 6; | /* number of shifts */ |
| int F; | |
| int G; | |
| int D; | /* window shift */ |
| int T; | /* Nominal symbol period */ |
| int L; | /* Repetition pattern period */ |
| int E; | |
| int W; | /* window length */ |
| int S; | /* window shift */ |
| int U; | /* accumulated shift */ |
| int V; | |
| int gcd; | /* great common divider */ |
| double e; | /* error */ |

| | |
|---|---|
| int i; | |
| gcd | = fGCD( f, g ); |
| F | = f / gcd; |
| G | = g / gcd; |
| D | = (int)( (double)( d * g ) / f + .5 ); |
| T | = 2 * d * ( s + 1 ); |
| L | = F + 1; |

```
      U = 0;
      for ( i = 1; i < L; i++ ) {
          E = ( 4 * G * d * i + F ) / ( 2 * F );
          if ( E % 2 == 0 ) {
                W = 2 * D;
          }
          else {
                W = 2 * D + 1;
          }
          V = ( E − W ) / 2;
          S = V − U;
          U = V;
          e  = ( double )( d * i * G ) / F − ( double )E / 2;
      }
      return 0;
}
```

The code is not generalized to all conditions, however the skilled person is able to adapt the code for a specific condition if necessary.

TABLE 1

| i | W | o | e |
|---|---|---|---|
| 1 | 9 | 0 | −0.15 |
| 2 | 9 | 4 | 0.21 |
| 3 | 8 | 5 | 0.06 |
| 4 | 9 | 4 | −0.09 |
| 5 | 8 | 5 | −0.23 |
| 6 | 8 | 4 | 0.12 |
| 7 | 9 | 4 | −0.02 |
| 8 | 8 | 5 | −0.17 |
| 9 | 8 | 4 | 0.18 |
| 10 | 9 | 4 | 0.04 |
| 11 | 8 | 5 | −0.11 |
| 12 | 8 | 4 | 0.24 |
| 13 | 9 | 4 | 0.10 |
| 14 | 8 | 5 | −0.05 |
| 15 | 9 | 4 | −0.19 |
| 16 | 9 | 4 | 0.16 |
| 142 | 8 | 4 | 0.23 |
| 143 | 9 | 4 | 0.09 |
| 144 | 8 | 5 | −0.06 |
| 145 | 9 | 4 | −0.21 |
| 146 | 9 | 4 | 0.15 |
| 147 | 8 | 5 | 0.00 |

TABLE 1 shows the sequence number, i, the width, W, of the window function, the offset, o, and the error, e, made at window maxima. The first 14 sub-windows of TABLE 1 are shown in FIG. 2B.

The error is always limited to a maximum of plus or minus ¼ of a sample.

The sequence repeats indefinitely without accumulation errors if a minimum of number of windows is taken into account. This number is given by the reference frequency divided by the great common divider between the reference and the target frequencies.

These windows are stored in memory. Conversely, one can store only the two base windows and the list of widths and offsets. Another option could be to run the given algorithm to find out the current window width and offset.

The modified watermark sequence obtained would for the watermark of FIG. 1A be a first symbol of width 9, a second symbol of width 9, a third symbol of width 8, etc. FIG. 2B illustrates the principle for the first 14 windows. Here, the minimum number of windows to be taken into account is 44,100/300=147. The number 300 being the great common divider between the 44,100 and 48,000.

The window shaping function may have an anti-symmetric temporal behavior or a bi-phase behavior. The bi-phase window may comprise at least to Hanning windows of opposite polarities. The use of such window shaping functions may offer improved performance, both with respect to audibility and robustness as disclosed in the published patent applications WO 03/083858, WO 03/083860 and WO 05/029466.

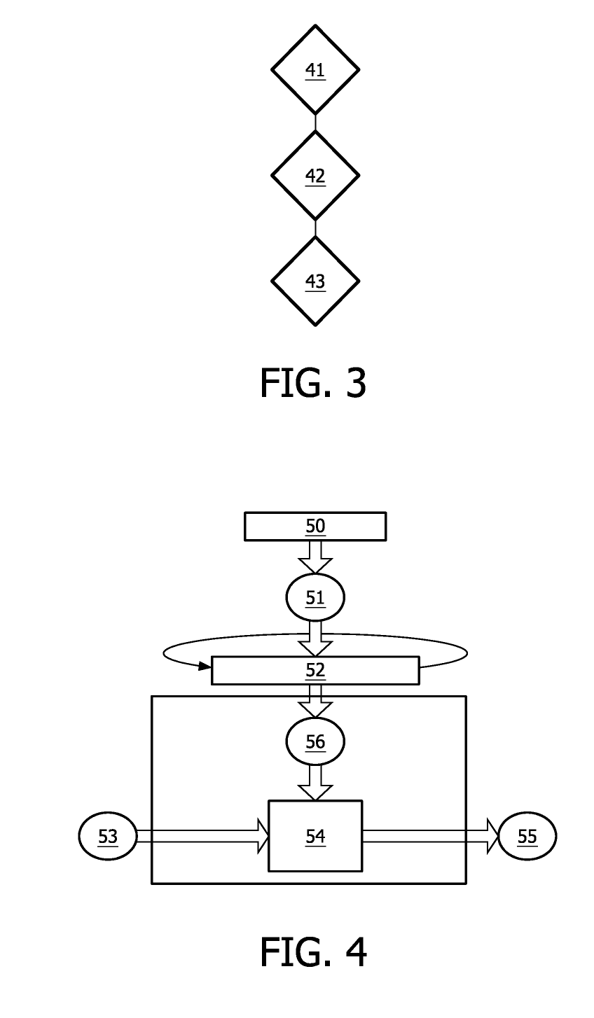

FIG. 4 illustrates flowchart of an embodiment in accordance with the present invention for embedding a watermark into a multimedia signal.

In an initialization process, a watermark sampled at a first sampling frequency is filled into a watermark payload buffer 50, so that a watermark sequence w[f₀] including the payload is generated 51, f₀ referring to the first sampling frequency. The watermark w[f₀] is frequency-matched and stored in a watermark payload buffer 52 by application of the method as explained in connection with the FIGS. 1 to 3. The frequency matched watermark, w[f₁] is outputted 56, f₁ representing the second frequency. The frequency matched watermark is inserted into an embedder 54 together with the multimedia signal sampled at f₁. So that the multimedia signal at frequency f₁ at 53 including a watermark x+w[f₁] is outputted at 55.

In the embodiment illustrated in FIG. 4, the payload is generated in the watermark sampled at the first frequency. In an alternative embodiment, the payload is first included after the watermark has been matched to the first sampling frequency. That is, the payload is imposed on to the watermark w[f₁], before it is outputted at 56.

The buffer 52 is filled with each of e.g. 1,024 watermark symbols for each sequence repeated a number of times (the respective shaping window length) for as many sub-windows as the minimum given in the description, say 147. Resulting in about 61,000 values for 48 kHz. If memory can be a problem, one may prefer to calculate the respective watermark value on the fly with the given C-code, and one can reduce the circular buffer to 1,024 times the number of unique sequences (1, 3 or 7).

To this end, the generation of the modified watermark signal may comprise generating a number of circularly shifted sequences of symbols, the sequences circularly shifted with respect to a non-shifted sequence and generating the modified watermark signal by adding the values of the shifted sequences. That is in a similar way as a payload may be embedded into the watermark at the first frequency.

A more detailed description of embedding a watermark into a multimedia signal can be found in the published patent applications WO 03/083858, WO 03/083860 and WO 05/029466. In those disclosures only a reference sequence and a single shifted sequence are disclosed. However, the skilled person would be able to extend the disclosure to the one as presented here, in connection with the figures.

The watermark may be detected and the payload extracted in a process including the steps of receiving the multimedia signal that may potentially be watermarked by a watermark signal modifying the host multimedia signal. An estimate of the watermark may be extracted from the received signal, and the estimate may be processed with a respect to a reference version of the watermark so as to determine whether the received signal is watermarked. The processing may include a correlation processing. Again, a more detailed description of performing the tasks may be found in the published patent applications WO 03/083858, WO 03/083860 and WO 05/029466.

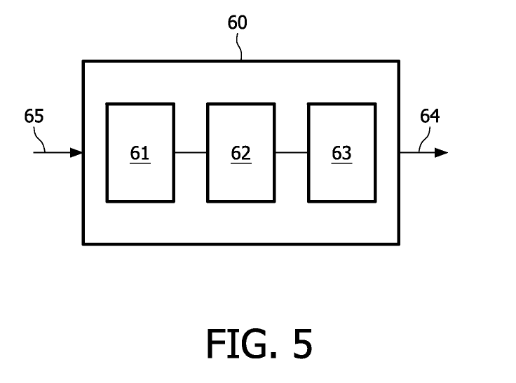

FIG. 5 schematically illustrates an apparatus for matching a watermark sampled at a first sampling rate to multimedia sampled at a second rate. Embodiment of the present invention may be implemented into an apparatus 60 comprises a receiver unit 61 for receiving the watermark 62 sampled at the first sampling rate. A determination unit 62 for determining the scaling factors and setting re-scale widths. A modifier unit 63 for generating and outputting 64 a modified watermark.

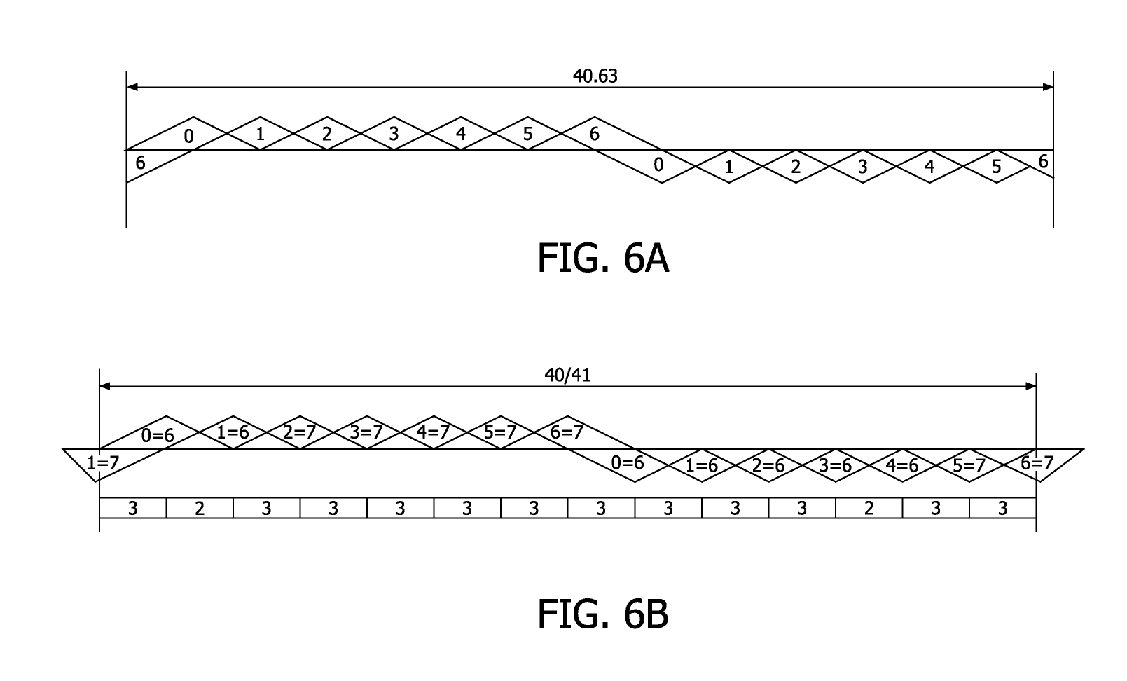

FIG. 6A is related to FIG. 2A whereas FIG. 6B is related to FIG. 2B in that the figures relates to down-sampling instead of up-sampling as in the case of FIGS. 2A and 2B.

FIG. 6A illustrates the watermarks window of FIG. 1B re-sampled to 32 kHz, whereas FIG. 6B illustrates a modified watermark window at 32 kHz in accordance with embodiments of the present invention.

In FIG. 6A the watermark window of FIG. 1B is re-sampled by a non non-integer factor. In this situation, the 56 samples of the watermarks window at 44.1 kHz (FIG. 1B) is re-sampled to 40.63 samples.

A re-sampled watermark window at 32 kHz with either 40 or 41 samples is illustrated in FIG. 6B. The watermark window is obtained by applying the steps as explained in connection with the FIGS. 1 to 3. Here, the minimum number of windows to be taken into account is 44,100/100=441. FIG. 6B shows only the first 14 windows. The number 100 being the great common divider between the 44,100 and 32,000.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

While the above embodiments have been described with reference to an audio signal, it will be appreciated that the present invention can be applied to other types of signal, for instance video and data signals.

In summary, the invention deals with matching of a watermark to a host sampling rate of a multimedia signal. A watermark sampled at a first sampling rate is matched to multimedia host signal sampled at a second sampling rate, in a process where the watermark sampled at the first sampling rate is received, a scaling factor between the first sampling rate and the second sampling rate is determined, and re-scale widths of the watermark symbols are set. A modified watermark is generated wherein the watermark symbols of the modified watermark being of re-scale widths, so as to substantially match the modified watermark sequences to the second sampling rate.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method of matching a watermark sampled at a first sampling rate to multimedia host signal sampled at a second sampling rate, the method comprising:
receive (41) the watermark sampled at the first sampling rate, the watermark being based on a number of watermark sequences, each watermark symbol of each watermark sequence being repeated by a first integer width;
determinate (42) the scaling factor between the first sampling rate and the second sampling rate, and determine a first re-scale width of the watermark symbols so as to approximate the watermark sequences to the second sampling rate, and set at least two integer re-scale widths, wherein at least a second re-scale width being larger than or equal to the first re-scale width and at least a third re-scale width being smaller than or equal to the first re-scale width;
generate (43) a modified watermark based on the number of watermark sequences, wherein the watermark symbols of the modified watermark being of either the at least second or third re-scale width, so as to substantially match the modified watermark sequences to the second sampling rate.

2. The method according to claim 1, wherein a modified watermark window is generated so that a circular buffer (52) of modified watermark sequences is generated.

3. The method according to claim 2, wherein a modified watermark window is generated, and wherein the number of sub-windows (0-6) of the modified watermark window is the minimum number so as to provide a circular buffer (52), under the constraint that a boundary errors of sub-windows are minimized.

4. The method according to claim 1, wherein the second re-scale width being the integral part of the first re-scale width, and wherein the third re-scale width being the second re-scale width incremented by 1.

5. The method according to claim 2, wherein the order of the symbols of the modified watermark sequence having either second or third re-scale width is determined under the constraint that a boundary errors of sub-windows of the modified watermark window are minimized.

6. The method according to claim 5, wherein the modified sequence of watermark symbols is convoluted with a window shaping function (14) so as to form a smoothly varying signal, the width of the window shaping function being adapted to the width of the symbols of the modified watermark sequence.

7. The method according to claim 2, wherein the window shaping function for at least some of the symbols of the modified watermark sequence is offset by an integer value under the constraint that a boundary errors of sub-windows of the modified watermark window are minimized.

8. The method according to claim 7, wherein the offset is in the range of the integral of half the first re-scaling width, incremented by 1 or decreased by 1.

9. The method according to claim 1, wherein the generation of the modified watermark signal comprise:
generating a number of circularly shifted sequences of symbols, the sequences circularly shifted with respect to a non-shifted sequence
generating the modified watermark signal by adding the values of the shifted sequences.

10. The method according to claim 6, wherein the window shaping function has an anti-symmetric temporal behavior or a bi-phase behavior.

11. The method according to claim 1, further comprising the step of embedding the modified watermark into the multimedia host signal of the second sampling rate.

12. An apparatus (60) for matching a watermark sampled at a first sampling rate to multimedia host signal sampled at a second sampling rate, the apparatus comprising:
a receiver unit (61) for receiving the watermark (65) sampled at the first sampling rate, the watermark being based on a number of watermark sequences, each watermark symbol of each watermark sequence being repeated by a first integer width;
a determination (62) unit for determining the scaling factor between the first sampling rate and the second sampling rate, and determine a first re-scale width of the watermark symbols so as to approximate the watermark sequences to the second sampling rate, and set at least two integer re-scale widths, wherein at least a second re-scale width being larger than or equal to the first re-scale width and at least a third re-scale width being smaller than or equal to the first re-scale width;
a modifier unit (63) for generating a modified watermark based on the number of watermark sequences, wherein the watermark symbols of the modified watermark being of either the at least second or third re-scale width, so as to substantially match the modified watermark sequences to the second sampling rate.

13. A watermark host signal, wherein the watermark comprise a number of watermark sequences, wherein the watermark symbols being of either an at least second or third re-scale width, so as to substantially match the watermark sequences to the sampling rate of the host signal.

14. Computer readable code for implementing the method of claim 1.
